(19) United States
(12) Patent Application Publication
(10) Pub. No.: US 2015/0043844 A1
(43) Pub. Date: Feb. 12, 2015

(54) SINTERED METAL BEARING

(71) Applicant: NTN CORPORATION, Osaka (JP)

(72) Inventors: Masaharu Hori, Mie (JP); Hiroshi Akai, Mie (JP); Tetsuya Kurimura, Mie (JP); Fuyuki Ito, Mie (JP)

(73) Assignee: NTN CORPORATION, Osaka (JP)

(21) Appl. No.: 14/385,865

(22) PCT Filed: Mar. 18, 2013
(86) PCT No.: PCT/JP2013/057660

§ 371 Date: Sep. 17, 2014

(30) Foreign Application Priority Data
Mar. 19, 2012 (JP) 2012-061849
Mar. 27, 2012 (JP) 2012-072527

(51) Int. Cl. F16C 32/06

(52) U.S. Cl. CPC F16C 32/0666; F16C 32/0629
USPC 384/114

(57) ABSTRACT

Provided is a sintered metal bearing, which is formed of raw material powder containing copper-based powder and iron-based powder as main components, the sintered metal bearing including a radial bearing surface along an inner periphery thereof. The copper-based powder includes fine copper powder exhibiting a particle size distribution in which a ratio of particles with a diameter of less than 45 μm is 80 wt % or more, the fine copper powder occupying one-third or more of a whole of the copper-based powder in terms of a weight ratio. A compressed body formed by compressing the raw material powder is sintered at 900° C. or more to 1,000° C. or less.

### TECHNICAL FIELD

The invention of this application (first invention of this application) relates to a sintered metal bearing, and more particularly, to a copper-iron-based sintered metal bearing. Moreover, the invention of this application (second invention of this application) relates to a material for a fluid dynamic bearing device, to a shaft member using the material, and to a fluid dynamic bearing device using the shaft member.

### BACKGROUND ART

A sintered metal bearing is used under a state in which lubricating oil is impregnated into inner pores thereof. The lubricating oil impregnated into the sintered metal bearing seeps into a sliding portion with respect to a shaft, which is inserted along an inner periphery of the sintered metal bearing, along with relative rotation of the shaft, to thereby form an oil film. The sintered metal bearing rotationally supports the shaft through this oil film. The sintered metal bearing has excellent rotational accuracy and quietness, and hence has been suitably used as a bearing for a motor to be mounted to various electrical apparatus such as information apparatus. Specifically, the sintered metal bearing has been suitably used in a spindle motor for an HDD or a disk drive device for a CD, a DVD, and a Blu-ray disc, a polygon scanner motor for a laser beam printer (LBP), or a fan motor.

As types of the sintered metal bearing, there are a copper-based type containing copper as a main component, an iron-based type containing iron as a main component, and a copper-iron-based type containing copper and iron as main components (for example, refer to Patent Literature 1). Among them, the copper-iron-based sintered metal bearing is suitably used for the above-mentioned bearing because the copper-iron-based sintered metal bearing can enjoy both of an enhancement effect of an oil film forming rate owing to excellent compressive deformability of copper, and an abrasion resistance enhancement effect of a bearing surface, which is obtained by high hardness inherent in iron.

That is, copper is a relatively soft metal, and accordingly, in a case of using this copper as a main component, the inner pores of the sintered metal bearing are prone to be closed, and as a result, oil permeability (easiness of permeating the lubricating oil in an event of delivering the lubricating oil from an inner diameter side of the sintered metal bearing to an outer diameter side thereof in a state of applying a constant pressure thereto) is lowered. When the oil permeability is low, the lubricating oil becomes less likely to be drawn to the inner pores of the sintered metal bearing. Accordingly, a pressure of the oil film formed in a bearing gap becomes likely to be increased, and excellent supportability by the oil film can be obtained. Moreover, iron is a metal with relatively high hardness, and accordingly, in a case of using this iron as a main component, hardness of the bearing surface of the sintered metal bearing is enhanced, and thus abrasion resistance of the bearing surface can be enhanced.

On the other hand, a fluid dynamic bearing device including a bearing such as the above-mentioned sintered metal bearing has high rotational accuracy and excellent quietness, and hence has been suitably used in a spindle motor for various disk drive devices (such as a magnetic disk drive device for an HDD and an optical disk drive device for a CD-ROM and the like), a polygon scanner motor for a laser beam printer (LBP), a color-wheel motor for a projector, or small motors such as a fan motor used, for example, for cooling electrical apparatus.

FIG. 14 illustrates an example of using this type of fluid dynamic bearing device for a disk drive device such as an HDD. In FIG. 14, reference numeral 101 denotes the fluid dynamic bearing device, reference numeral 102 denotes a shaft member, reference numeral 103 denotes a disk hub, reference numeral 104 denotes a stator coil, reference numeral 105 denotes a rotor magnet, reference numeral 106 denotes a motor base, reference numeral 107 denotes a housing, reference numeral 108 denotes a bearing sleeve, reference numeral 110 denotes a cover member, reference numeral 121 denotes a shaft portion, reference numeral 122 denotes a flange portion, and reference symbol D denotes a disk.

In the shaft member 102, in usual, as illustrated in FIG. 15A, a cylindrical clearance portion 102a, in which a diameter is slightly reduced, is formed on a part of an outer peripheral surface 121a of the shaft member 102. Then, a predetermined amount of lubricating oil is held between the clearance portion 102a and the bearing sleeve 108, and a radial gap is increased at the same time, to thereby reduce friction torque. Then, on a part of a cylindrical portion 102b and a part of a cylindrical portion 102c, which are located on both sides of the clearance portion 102a, dynamic pressure generating groove patterns A1 and A2, which form radial bearing portions, are formed.

The dynamic pressure generating groove patterns A1 and A2 are formed by a known rolling method (refer to FIG. 4 of Patent Literature 2) in such a manner that a shaft material. 102′, in which the cylindrical portions 102b and 102c are formed on both sides of the clearance portion 102a as illustrated in FIG. 15B, is sandwiched between a pair of upper and lower rolling dies. In such a way, for example, a plurality of dynamic pressure generating grooves G in a herringbone pattern are formed. Note that, the dynamic pressure generating groove patterns A1 and A2 which form the radial bearing portions are sometimes formed on an inner peripheral surface of a bearing member 109 by using a rolling ball and the like (refer to FIG. 1 of Patent Literature 3) instead of being formed on an outer peripheral surface of the shaft member 102. The shaft member 102 on which the dynamic pressure generating groove patterns A1 and A2 are formed by the rolling is thereafter subjected to heat treatment, and is formed as a quenched shaft. An outer peripheral surface of the quenched shaft is subjected to final finishing such as grinding, and thus the shaft member 102 as a completed product in which an outer peripheral surface is formed with predetermined accuracy is obtained. Then, onto an end portion of the shaft member 2, that is, onto an end portion of such a dynamic pressure generating groove forming region 102b, the flange portion 122 that forms a thrust bearing portion is mounted.

### CITATION LIST

Patent Literature 1: JP 2002-349575 A

Patent Literature 2: JP 7-114766 A

Patent Literature 3: JP 10-137886 A

### SUMMARY OF INVENTION

### Technical Problem

As described above, the copper-iron-based sintered metal bearing can combine characteristics of both of the copper-based sintered metal bearing and the iron-based sintered metal bearing with each other; however, on the other hand, sometimes causes the following defects. That is, when a ratio of a copper-based structure is increased, an advantage in that oil permeability is lowered is obtained; however, on the other hand, there occurs a defect that abrasion resistance is lowered. Meanwhile, when a ratio of an iron-based structure is increased, a merit that the abrasion resistance is enhanced is obtained; however, on the other hand, there occurs a defect that the oil permeability is increased. Therefore, in a case where levels of the required oil permeability and abrasion resistance are high, adjustment of only changing the ratio of the copper-based structure and the iron-based structure is sometimes insufficient for obtaining the sintered metal bearing excellent in both of the oil permeability and the abrasion resistance.

Here, for example, if a sintered density (apparent mass per unit volume in a case of not considering inner pores in the completed product) is enhanced, it is conceived that the oil permeability can be reduced due to the reduction of the inner pores. In particular, in a recent information apparatus (HDD or the like), as a storage capacity is increased, a weight of a rotor (including a spindle, a hub and a disk, which rotate integrally with the spindle, and the like) to be supported by the sintered metal bearing tends to be increased. Therefore, it is conceived that the increase of the sintered density is suitable for increasing strength (rigidity) of the sintered metal bearing and enhancing the abrasion resistance thereof. However, when a compression amount is increased to close the inner pores in order to enhance the sintered density, an amount of the oil impregnated into the sintered metal bearing is decreased, and accordingly, deterioration of the lubricating oil progresses rapidly, which may lead to rapid lowering of bearing performance. Considering the circumstances as described above, it is not easy to increase the sintered density more than at present.

Moreover, if stainless steel powder is used as the iron-based powder that forms the iron-based structure, the abrasion resistance can be enhanced without enhancing the sintered density. However, in general, the stainless steel powder is expensive in comparison with pure iron powder, and accordingly, the stainless steel powder does not accord with such an object that the abrasion resistance is enhanced without increasing a cost.

Further, with regard to forming of the above-mentioned dynamic pressure generating groove pattern, the rolling method is a processing method of obtaining a desired shape by moving a material on a surface of a raw material by plastic deformation, and accordingly, if the recessed clearance portion is present on the surface of the shaft material, a material flow directed to the clearance portion side is prone to occur. As illustrated in FIG. 15A, in the related-art shaft member 102, one-side regions A1a and A2a of the dynamic pressure generating groove patterns A1 and A2, on which the dynamic pressure generating grooves G are formed, are adjacent to the clearance portion 102a lower by one step, and a fluid is drawn from the clearance portion 102a to the dynamic pressure generating groove patterns A1 and A2. However, opposite-side regions of the dynamic pressure generating groove patterns A1 and A2 are directly continuous with the cylindrical portions 102b and 102c with the same height as that of the shaft member 102.

Therefore, a depth of the dynamic pressure generating grooves G tends to become deeper in the regions A1a and A2a, which are adjacent to the clearance portion 102a, than in the opposite-side regions A1b and A2b, and the depth of the dynamic pressure generating grooves G tends to become relatively shallow in the regions A1b and A2b on the opposite side to the clearance portion 102a because there is no space to which the material is drawn. As a result, as illustrated in a groove depth measurement result of FIG. 16, such a groove depth is inclined in an axial direction, and becomes unbalanced right and left, causing a problem in that stable dynamic pressure effect and radial bearing rigidity are not obtained. It is not impossible to solve the problem by changing a height of a protruding portion of a rolling jig, which serves for forming the dynamic pressure generating grooves. However, machining of the protruding portion is difficult, resulting in a cost increase.

In view of the above-mentioned circumstances, a first technical object to be achieved is to provide a copper-iron-based sintered metal bearing capable of exerting bearing performance of the existing level or more for a long period of time by enhancing the abrasion resistance and reducing the oil permeability at low cost.

Moreover, in view of the above-mentioned circumstances, a second technical object to be achieved is as follows. In an event of rolling and forming the dynamic pressure generating grooves of the dynamic pressure generating groove patterns in which the one-side regions are adjacent to the clearance portion, the depth of the grooves of the dynamic pressure generating groove patterns on the opposite side is prevented from becoming relatively shallow.

### Solution to Problem

The first technical object is attained by a sintered metal bearing according to a first invention of this application. That is, there is provided a sintered metal bearing, which is formed of raw material powder containing copper-based powder and iron-based powder as main components, the sintered metal bearing comprising a radial bearing surface along an inner periphery thereof, wherein the copper-based powder comprises fine copper powder exhibiting a particle size distribution in which a ratio of particles with a diameter of less than 45 μm is 80 wt % or more, the fine copper powder occupying one-third or more of a whole of the copper-based powder in terms of a weight ratio, and wherein a compressed body formed by compressing the raw material powder is sintered at 900° C. or more to 1,000° C. or less. Note that, the “copper-based powder” herein refers to metal powder containing copper as a main component, specifically, comprising not only pure copper powder but also alloy powder containing copper as a main component. Similarly, the “iron-based powder” refers to metal powder containing iron as a main component, specifically, comprising not only pure iron powder but also alloy powder containing iron as a main component.

As described above, the first invention of this application has a feature in that the copper powder (fine copper powder) different in particle size distribution from the copper powder used in the related art is used, and this powder is sintered at a temperature optimum for a case of using this powder. That is, the inventors of the first invention of this application have found out that the oil permeability is lowered to a larger extent in comparison with the case of using the related-art copper powder by using the copper powder, which exhibits the particle size distribution in which the ratio of the fine particles (particles with a diameter of less than 45 μm) is higher (80 wt % or more) than that in the copper powder used in the related art (refer to Table 1 to be shown below). In particular, the inventors have found out that a significant oil permeability reduction effect is obtained by using the copper-based powder in which the above-mentioned fine copper powder occupies one-third or more of the whole of the copper-based powder in terms of the weight ratio, preferably, occupies a half or more of the whole of the copper-based powder in terms of the weight ratio (refer to FIG. 5 to be shown later).

TABLE 1

| Particle | | Fine copper powder | | |
|---|---|---|---|---|
| size | Related-art copper powder | Lot A | Lot B | Lot C |
| >75 μm | 2.6 | 3.9 | 3.8 | 1.3 |
| 63-75 μm | 6.9 | 2.7 | 3.4 | 1.1 |
| 45-63 μm | 23.6 | 7.6 | 9.8 | 3.2 |
| <45 μm | 66.9 | 85.8 | 83.1 | 94.4 |

Unit: wt %

As described above, in order to lower the oil permeability, in the related art, there has been no other way but enhancing the sintered density. Meanwhile, the oil permeability can be suppressed to be low without enhancing the sintered density by using the copper-based powder in which the above-mentioned fine copper powder occupies one-third or more of the whole of the copper-based powder. Hence, even if the sintered density is the same as that in the related art, the fine copper powder may be used to lower the oil permeability and to enhance the oil film formation rate. Hence, in this case, by relatively increasing the ratio of the iron-based powder, it becomes possible to enhance the abrasion resistance.

Meanwhile, it has turned out that the oil permeability is lowered more than necessary in a case of using the fine copper powder and sintering the compressed body under the same conditions (sintered density, sintering temperature) as those in the related art. That is, as obvious from experiment results to be described below, if the oil permeability is attempted to be brought into an allowable range, it is necessary to set the sintered density to be smaller than an allowable numeric range. On the contrary, if the sintered density is attempted to be brought into an allowable range (the sintered density is attempted to be set at a relatively high value), the oil permeability falls below a lower limit value (0.1 g/10 min) of the allowable range. Accordingly, there has been a problem in that a balance cannot be struck between both of the cases (refer to FIG. 5 to be shown later). Reasons for this problem are as follows. As described above, as the load on the rotor is increased by the recent capacity increase of the HDD or the like, mechanical characteristics (strength, abrasion resistance) higher than those at present are required also for the sintered metal, bearing that supports the rotor. Meanwhile, if the sintered density is not sufficient, there occurs a problem in that strength and abrasion resistance cannot be ensured to necessary levels even if the ratio of the iron-based powder is increased. Therefore, it has turned out that, if priority is given to the sintered density, the oil permeability may become too small, and a circulation effect of the lubricating oil and a filter effect (effect of preventing the deterioration of the lubricating oil due to mixing of a foreign object by catching the foreign object mixed into the lubricating oil in the inner pores) of the lubricating oil, which should be originally inherent in the sintered metal bearing, may not be obtained.

The first invention of this application is made based on the knowledge described above, and has a feature in that the copper-based powder in the raw material powder of the sintered metal bearing comprises the fine copper powder occupying a fixed ratio, and in addition, in that the sintering temperature is set at 900° C. or more to 1,000° C. or less, which is higher than that in the related art. If the sintered metal bearing is obtained as described above, the sintered density can be set at a minimum level to be ensured while obtaining oil permeability in a range suitable for forming the oil film. That is, if the copper-based powder comprises the fine copper powder occupying one-third or more of the whole of the copper-based powder, the inner pores are prevented from being coarsened even if the sintering is carried out at 900° C. or more, and accordingly, required oil permeability can be ensured. Moreover, the sintering temperature is set at 900° C. or more. Thus, a sintering action is advanced, and bonding between the powder particles is strengthened more, and thus the strength (rigidity) and the abrasion resistance are enhanced. If the sintering temperature is 900° C. or more, it is easy to obtain the enhancement effect of the abrasion resistance, which is brought by the alloying. Moreover, the sintering temperature is suppressed to 1,000° C. or less, and thus a situation where copper is eluted excessively or is excessively alloyed with iron is avoided, and a copper-based structure can be left. In such a way, compression deformability inherent in copper, in other words, secondary processability after the sintering thereof is maintained, and thus dimensional accuracy (shape accuracy) after the sizing can be enhanced. Moreover, the copper-based structure is left on the bearing surface, and thus slidability (conformability) with the shaft can also be ensured. Hence, high abrasion resistance equivalent, for example, to that of a case where the stainless steel powder is used as the iron-based powder and is sintered at a related-art temperature can be acquired (refer to FIG. 6). In addition, the circulation effect and filter effect of the lubricating oil can be exerted sufficiently. Further, the sintered density can be set at an appropriate level, and thus the oil content can be set at a level that enables appropriate oil lubrication (circulation). Accordingly, a rapid deterioration of the lubricating oil can be prevented together with the above-mentioned circulation effect and filter effect. From the above, it becomes possible to exert excellent bearing performance for a long period of time.

Further, in the sintered metal bearing according to the first invention of this application, a sintered density may be set at 6.70 g/cm³ or more to 7.20 g/cm³ or less. As described above, according to the first invention of this application, while obtaining the oil permeability in the range suitable for forming the oil film, the sintered density can be set at the minimum level to be ensured, and the mechanical characteristics (rigidity, abrasion resistance, and the like) equivalent to or more than the existing level can be obtained. Hence, even in the case where the sintered density is set within the above-mentioned range, it becomes possible to set the oil permeability within an appropriate range, specifically, a range of 0.10 g/10 min or more to 2.00 g/10 min or less. In such a way, escape of an oil pressure is suppressed, and in particular, escape of the dynamic pressure is suppressed effectively in a case of providing dynamic pressure generating portions on the radial bearing surface of the sintered metal bearing or one or both axial end surfaces thereof. Thus, a sufficient dynamic pressure effect can be exerted, and accordingly, a high oil film pressure can be formed and maintained. Hence, while obtaining high rotation accuracy, the filter effect and circulation effect of the lubricating oil owing to the inner pores are exerted sufficiently, and thus it becomes possible to minimize the deterioration of the lubricating oil.

Moreover, if the sintered density can be set within the above-mentioned range, the oil content of the obtained sintered metal bearing can be set at 10 vol % or more to 14 vol % or less. In this way, appropriate oil circulation can be achieved. Note that, the “oil content” herein refers to an oil amount represented in volume percent, which is impregnated in the sintered metal, specifically, represented by (W2−W1)/(W3×ρ)×100 [vol %](JIS Z2501), where W1 is a weight of a sintered metal bearing that has not yet been impregnated with lubricating oil, W2 is a weight of the sintered metal bearing in which lubricating oil is impregnated as much as possible in inner pores, W3 is a volume of the sintered metal, and ρ is a density of the impregnated lubricating oil.

Moreover, in the sintered metal bearing according to the first invention of this application, the iron-based powder may comprise pure iron powder. Alternatively, the iron-based powder may comprise the pure iron powder and stainless steel powder.

Moreover, in a case where the iron-based powder comprises iron powder, an occupancy ratio of the copper-based powder in the raw material powder may be set at 10 wt % or more to 40 wt % or less. In a case where the iron-based powder comprises the iron powder and the stainless steel powder, the occupancy ratio of the copper-based powder in the raw material powder may be set at 10 wt % or more to 60 wt % or less.

As described above, a composition of the iron-based powder and the copper-based powder in the raw material powder is determined, and the sintered metal bearing is formed under the above-mentioned sintering conditions (sintering temperature, sintered density). Thus, it is possible to obtain the sintered metal bearing that exhibits the oil permeability and the oil content within the above-mentioned ranges.

Moreover, in the sintered metal bearing according to the first invention of this application, the raw material powder may have graphite further blended therewith, or the raw material powder may have tin powder further blended therewith.

Moreover, in the sintered metal bearing according to the first invention of this application, a surface aperture ratio of the radial bearing surface may be set at 2% or more to 15% or less, or may be set at 2% or more to 12% or less. As described above, the surface aperture ratio of the radial bearing surface is set at 15% or less so that escape of the oil pressure (dynamic pressure in a case where the dynamic pressure generating portion is provided) to the inside of the bearing is prevented, and it becomes possible to maintain a high oil film pressure. Moreover, the surface aperture ratio is set at 2% or more so that the filter effect and anti-seizing property, which are inherent in the sintered metal bearing, can be ensured.

Moreover, the sintered metal bearing according to the above description achieves the enhancement of the abrasion resistance and the reduction of the oil permeability at low cost, and is thereby capable of exerting the bearing performance, of which level is equal to or more than the existing level, for a long period of time. Accordingly, for example, the sintered metal bearing can be suitably used for a fluid dynamic bearing device comprising: this sintered metal bearing; a shaft arranged along an inner periphery of the sintered metal bearing; and lubricating oil impregnated into the sintered metal bearing.

Moreover, the second technical object is attained by a material for a fluid dynamic bearing device according to a second invention of this application. That is, this material is a material for a fluid dynamic bearing device for a bearing member or a shaft member for use in a fluid dynamic bearing device in which the shaft member is inserted into the bearing member and a radial bearing portion is formed between both of the members. The material comprises: a dynamic pressure generating groove forming region on which a plurality of dynamic pressure generating grooves for generating a dynamic pressure action on the radial bearing portion are formed by rolling; a clearance portion having a larger depth than that of the dynamic pressure generating grooves so as to be capable of holding a fluid supplied to the dynamic pressure generating grooves, the clearance portion being adjacent to one side of the dynamic pressure generating groove forming region; and a clearance groove adjacent to another side of the dynamic pressure generating groove forming region.

As described above, on an opposite side of the dynamic pressure generating groove forming region, the clearance groove that generates a material flow similar to a material flow to a clearance portion direction is provided. In such a way, a material flow in rolling formation of the dynamic pressure generating grooves can be equalized on both sides of the dynamic pressure generating groove forming region, and an axial gradient of a depth of the dynamic pressure generating grooves can be eliminated. In such a way, the depth of the dynamic pressure generating grooves is balanced, and stable dynamic pressure effect and radial bearing rigidity are obtained.

The dynamic pressure generating groove forming region can be formed on at least two positions while sandwiching the clearance portion therebetween. In this way, while suppressing an increase of rotation torque by the clearance portion, moment rigidity of the shaft member can be enhanced by the at least two radial bearing portions arranged apart from each other. Moreover, it becomes possible to supply the fluid, which is held on the clearance portion, abundantly to the radial bearing portion, and the rotation accuracy in the radial direction is stabilized. Note that, in a case of forming the clearance portion on the shaft member side, the inner peripheral surface on the bearing member side is formed into a perfect circle cylindrical surface with a constant diameter so that manufacturing cost is reduced, and meanwhile, a fluid reservoir can be provided between the outer peripheral surface of the shaft member and the inner peripheral surface of the bearing member.

It is recommended that a depth of the clearance groove be set at the depth of the dynamic pressure generating grooves or more to the depth of the clearance portion or less, desirably, set to have substantially the same depth as the clearance portion. Specifically, it is desired that the depth of the clearance groove be set at 20 μm or more to 50 μm or less. This is because an effect of accelerating the material flow is insufficient if the depth of the annular groove is 20 μm or less, and meanwhile, a particular effect of further enhancing the material flow is not obtained even if the depth is set at 50 μm or more. Moreover, the depth of the clearance groove is set to have substantially the same depth as the clearance portion so that the depth of the dynamic pressure generating grooves is balanced more favorably, and the stable dynamic pressure effect and radial bearing rigidity are obtained.

It is desired that a width of the clearance groove be set at 0.5 mm or less. This is because such a particular effect of further enhancing the material flow is not obtained even if the width of the clearance groove is set to exceed 0.5 mm. In particular, in a shaft material for a fluid dynamic bearing device, in which a sealing portion is formed on an outer side of the clearance groove, if the width of the clearance groove exceeds 0.5 mm, a part of the clearance groove enters the sealing space (tapered portion) too much, a gap interval of the sealing space is widened, capillary force thereof is weakened, and sealing performance thereof is lowered.

In order to facilitate work in subsequent processes, and so on, it is desired that the shaft material be subjected to surface hardening by being subjected to heat treatment in advance before the rolling formation of the dynamic pressure generating grooves. With regard to the dynamic pressure generating grooves formed on the outer peripheral surface of the shaft member, a depth dimension regarded to be necessary is on a micron order, and accordingly, even in the case of implementing rolling processing for a surface hardened layer (quenched shaft) formed by the heat treatment, the dynamic pressure generating grooves with a predetermined depth dimension can be formed.

In addition, it is no longer necessary to perform the heat treatment on the shaft material after the dynamic pressure generating grooves are formed by rolling, in other words, under a state in which internal stress is accumulated in the shaft material, and hence deformation due to distortion is less liable to occur. Thus, depending on cases, final finishing can be omitted, or a processing amount thereof can be reduced even when the final finishing is performed.

Further, a removal step of removing black scale formed on a surface layer portion of the surface hardened layer (external surface of the quenched shaft) can be performed prior to the rolling process. The outer peripheral surface of the quenched shaft before the rolling process has a shape of a substantially smooth cylindrical surface that does not have fine irregularities such as the dynamic pressure generating recessed portions, and hence the black scale can be easily removed. As a result, a problem of deterioration in bearing performance, which may be caused by contaminants derived from the black scale that has peeled off from the shaft member, is less liable to occur.

The bearing member can comprise a porous body or a sintered metal. In such a way, the lubricating oil can be impregnated and held in inner pores of the porous body or the sintered metal, and even if the lubricating oil in the clearance portion is drawn to the radial bearing gap side and a pressure of the lubricating oil in the clearance portion is lowered, the lubricating oil impregnated in the inner pores of the bearing member is supplied from surface pores of the clearance portion into the clearance portion, and an occurrence of a negative pressure in the clearance portion can be prevented.

A fluid dynamic bearing device that uses the material for a fluid dynamic bearing device described above according to the second invention of this application can be suitably used when being incorporated in a motor comprising stator coils and a rotor magnet, such as a spindle motor for disk drive devices.

### Advantageous Effects of Invention

As described above, according to the sintered metal bearing of the first invention of this application, it is possible to exert bearing performance of the existing level or more for a long period of time by enhancing the abrasion resistance and reducing the oil permeability at low cost.

Moreover, as described above, according to the material for a fluid dynamic bearing device of the second invention of this application, the clearance groove is provided on the opposite side to the clearance portion in the dynamic pressure generating groove forming region. Thus, the material flow at the time of the rolling formation of the dynamic pressure generating grooves is equalized on both sides of the dynamic pressure generating groove forming region, and the axial gradient of the depth of the dynamic pressure generating grooves can be eliminated. In such a way, the depth of the dynamic pressure generating grooves is balanced, and the stable dynamic pressure effect and radial bearing rigidity can be obtained.

### BRIEF DESCRIPTION OF DRAWINGS

FIG. 1 is a cross-sectional view of a motor to which a sintered metal bearing according to an embodiment of a first invention of this application is applied.

FIG. 2 is a cross-sectional view of a fluid dynamic bearing device that forms the motor of FIG. 1.

FIG. 3 is a cross-sectional view of the sintered metal bearing according to an embodiment of the first invention of this application.

FIG. 4 is a bottom view of the sintered metal bearing illustrated in FIG. 3.

FIG. 5 is a graph showing relationships between sintered densities and oil permeabilities of sintered metal bearings.

FIG. 6 is a graph showing relationships between sintering temperatures and abrasion depths of the sintered metal bearings.

FIG. 7 is a side view conceptually illustrating an oil permeability testing apparatus.

FIG. 8A is an enlarged cross section photograph of the sintered metal bearing, showing a relationship between the sintering temperature and a size of inner pores.

FIG. 8B is an enlarged cross section photograph of the sintered metal bearing, showing a relationship between the sintering temperature and the size of the inner pores.

FIG. 8C is an enlarged cross section photograph of the sintered metal bearing, showing a relationship between the sintering temperature and the size of the inner pores.

FIG. 9 is a shaft-including cross-sectional view of a fluid dynamic bearing device according to an embodiment of a second invention of this application.

FIG. 10A is a side view of a shaft member.

FIG. 10B is a side view of a shaft material.

FIG. 11 is a block diagram illustrating a production process of the shaft member.

FIG. 12 is a diagram illustrating a measurement result of depths of dynamic pressure generating grooves of the shaft member.

FIG. 13A is a side view of a modification example of the shaft member.

FIG. 13B is a side view of a shaft material.

FIG. 14 is a cross-sectional view conceptually illustrating an example of an information apparatus spindle motor into which a related-art fluid dynamic bearing device is incorporated.

FIG. 15A is a side view of a related-art shaft member.

FIG. 15B is a side view of a related-art shaft material.

FIG. 16 is a diagram illustrating a measurement result of depths of dynamic pressure generating grooves of the related-art shaft member.

### DESCRIPTION OF EMBODIMENTS

Now, an embodiment of a first invention of this application is described with reference to the drawings.

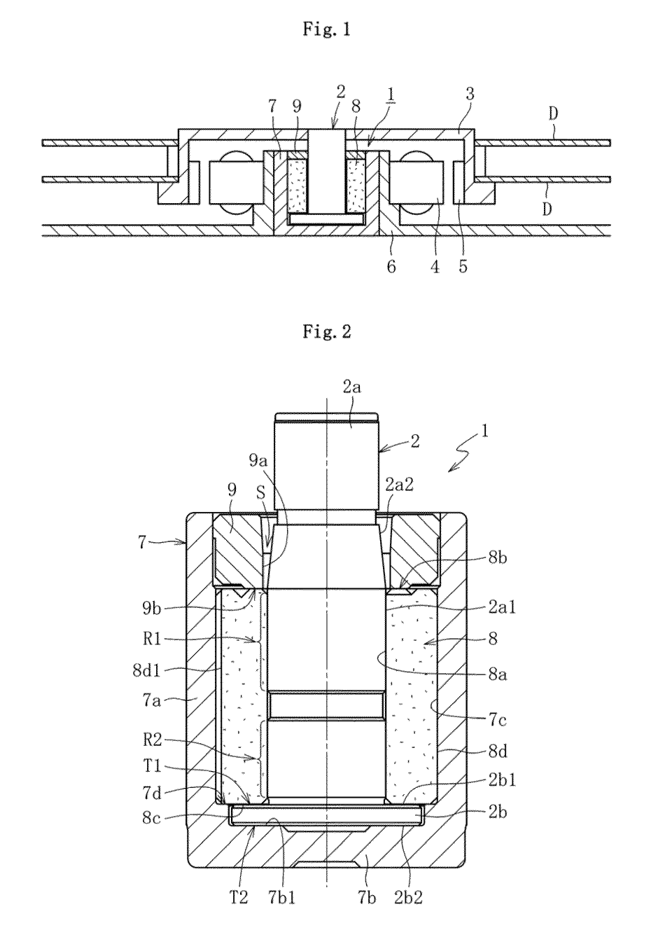

As illustrated in FIG. 1, this spindle motor is used in a disk drive device, such as an HDD, and comprises a fluid dynamic bearing device 1 for supporting a shaft member 2 rotatably in a non-contact fashion, a disk hub 3 mounted to the shaft member 2, a stator coil 4 and a rotor magnet 5 that are opposed each other through the intermediation of a radial gap, and a motor bracket 6. The stator coil 4 is mounted to the outer periphery of the motor bracket 6, and the rotor magnet 5 is mounted to the inner periphery of the disk hub 3. The disk hub 3 retains in its outer periphery one or a plurality of (two in FIG. 1) disks D. In the spindle motor constructed as described above, when the stator coil 4 is energized, the rotor magnet 5 is caused to rotate, and with this rotation, the disk hub 3 and the disks D retained by the disk hub 3 rotate integrally with the shaft member 2.

The fluid dynamic bearing device 1 comprises, as illustrated in FIG. 2, the shaft member 2, a closed-end cylindrical housing 7, a sintered metal bearing 8 according to an embodiment of the first invention of this application, and a sealing member 9. Note that, in the following description, the axial closed side of the housing 7 is referred to as the lower side and the opened side thereof is referred to as the upper side for the sake of easy understanding of the description.

The shaft member 2 is formed, for example, of a metal material such as stainless steel, and comprises a shaft portion 2a and a flange portion 2b, which is provided at a lower end of the shaft portion 2a, integrally with each other or separately from each other. The shaft portion 2a has a cylindrical outer peripheral surface 2a1 and a tapered surface 2a2 gradually reduced in diameter toward an upper side thereof. The shaft member 2 is arranged so that the outer peripheral surface 2a1 of the shaft portion 2a can be located along an inner periphery of the sintered metal bearing 8, and that the tapered surface 2a2 can be located along an inner periphery of the sealing member 9.

The housing 7 comprises a cylindrical side portion 7a and a bottom portion 7b, which closes a lower end of the side portion 7a, integrally with each other. The sintered metal bearing 8 is fixed to an inner periphery of the side portion 7a. On an upper end surface 7b1 of the bottom portion 7b of the housing 7, dynamic pressure generating grooves, for example, in a spiral pattern are formed (not shown) as a thrust dynamic pressure generating portion for generating a dynamic pressure action on an oil film of a thrust bearing gap.

The sintered metal bearing 8 is made of a copper-iron-based sintered metal containing copper and iron as main components. The sintered metal bearing 8 is obtained by sintering a compact formed by compressing raw material powder containing copper-based powder and iron-based powder, and is made of, for example, a so-called copper-iron-based sintered metal containing copper and iron as main components. In the copper-based powder for use in the sintered metal bearing 8, fine copper powder exhibiting a particle size distribution in which a ratio of particles with a diameter of less than 45 μm is 80 wt % or more occupies one-third or more of the whole of the copper-based powder in terms of a weight ratio. For example, copper-based powder is used, which is formed by mixing pure copper powder (fine copper powder) exhibiting the above-mentioned particle size distribution and pure copper powder (related-art composition copper powder) exhibiting the particle size distribution in which a ratio of particles with a diameter of less than 45 μm is less than 70 wt %, for example, as shown in Table 1, with each other so that a weight ratio thereof can be 1:2 (so that an occupancy ratio of the fine copper powder in the whole of the copper-based powder can be one-third). Moreover, as the iron-based powder, one including only pure iron powder or one including the pure iron powder and powder of an iron alloy such as stainless steel is used. For example, the iron-based powder including only the pure iron powder is used. In this case, blending ratios of the copper-based powder and the iron-based powder are set so as to be 10 wt % or more to 40 wt % or less for the copper-based powder with respect to a whole of raw material powder and be 60 wt % or more to 90 wt % or less for the iron-based powder with respect thereto.

Moreover, graphite, tin powder, and the like are blended with the above-mentioned raw material powder as necessary. Here, the graphite is blended for the purpose of enhancing slidability with a metal mold at a forming stage and enhancing slidability with an opposite material (shaft member) in a completed product. The tin powder is converted into a liquid layer at a relatively low temperature at a time of the sintering. Therefore, the tin powder is blended for the purpose of assisting binding of other powder by entering gaps between powder particles. Alternatively, as a substitution of the expensive stainless steel powder, iron-phosphorus alloy powder may be blended for the purpose of enhancing abrasion resistance. As an example, in a case where the raw material powder comprises the copper-based powder, the iron-based powder (only the pure iron powder), the graphite, and the tin powder, blending ratios of the respective types of powder are set so as to be, with respect to the whole of the raw material powder, 10 wt % or more to 40 wt % or less for the copper-based powder, 50 wt % or more to 90 wt % or less for the iron-based powder, 0.5 wt % or more to 2.0 wt % or less for the graphite, and 1.0 wt % or more to 5.0 wt % or less for the tin powder.

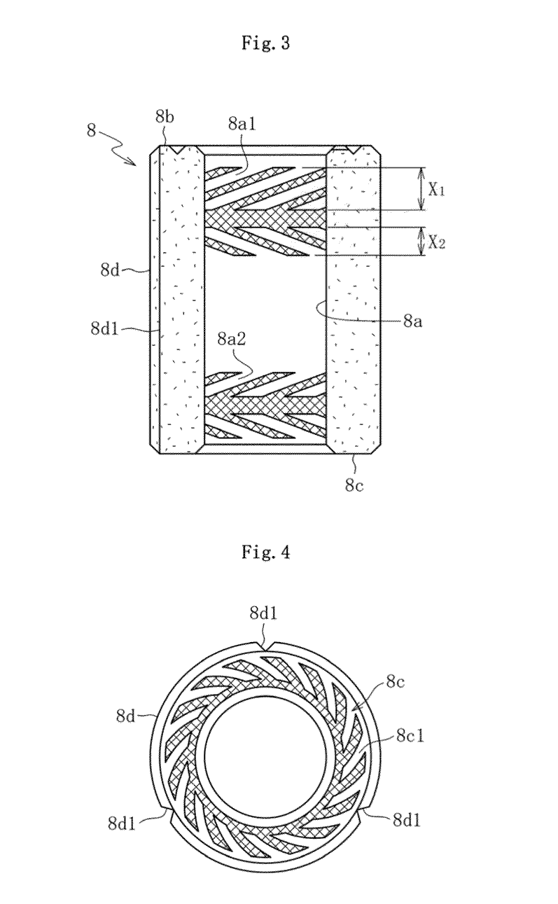

The raw material powder determined as described above is compressed and formed into a predetermined shape (shape that conforms to the completed product illustrated in FIG. 3). This compressed body is sintered at a predetermined sintering temperature, and thus a sintered body is obtained. Then, as necessary, this sintered body is subjected to dimension sizing, to rotation sizing (hole sealing treatment for the inner peripheral surface), and to dynamic pressure generating groove sizing, and thus a sintered metal bearing as the completed product is obtained.

Moreover, in this case, the sintered density is set within a range of 6.70 g/cm³ or more to 7.20 g/cm³ or less. The sintering temperature is equal to or less than the melting point of copper, and is set within a range of 900° C. to 1,000° C., preferably, is set within a range of 930° C. or more to 970° C. or less. Moreover, oil permeability in the completed product is set within a range of 0.10 g/10 min or more to 2.00 g/10 min or less. An oil content in the completed product is set within a range of 10 vol % or more to 14 vol % or less.

As described above, in the copper-based powder, the above-mentioned fine copper powder occupies one-third oz more of the whole of the copper-based powder, and thus the oil permeability can be suppressed to be low without enhancing the sintered density. Hence, even if the sintered density is the same as the related art, the oil permeability is lowered by using the fine copper powder so that it becomes possible to enhance an oil film formation rate. In this case, the ratio of the iron-based powder is relatively increased so that it becomes possible to enhance the abrasion resistance. Moreover, in addition to the usage of the fine copper powder, the sintering temperature is set at 900° C. or more, which is higher than the related art. Accordingly, while the inner pores are prevented from being coarsened and oil permeability in a range suitable for forming the oil film is obtained, the sintered density is set at a minimum level to be ensured, and thus high strength (rigidity) and abrasion resistance can be obtained. Further enhancement of the abrasion resistance by moderate alloying can also be expected. Moreover, the sintering temperature is suppressed to 1,000° C. or less. Thus, a situation where copper is eluted excessively or is alloyed with iron is avoided, and a copper-based structure can be left. In such a way, compression deformability inherent in copper is maintained, and dimensional accuracy after the sizing can be enhanced. Moreover, the copper-based structure is left on a bearing surface, and thus slidability (conformability) with the shaft can also be ensured. Hence, high abrasion resistance equivalent, for example, to that of a case where the stainless steel powder is used as the iron-based powder and is sintered at a related-art temperature can be acquired. In addition, a circulation effect and filter effect of the lubricating oil can be exerted sufficiently. Moreover, the sintered density can be set at an appropriate level, and thus the oil content can be set at a level that enables appropriate oil lubrication (circulation). Accordingly, a rapid deterioration of the lubricating oil can be prevented together with the above-mentioned circulation effect and filter effect. From the above, it becomes possible to exert excellent bearing performance for a long period of time.

The pure copper powder (fine copper powder) exhibiting the above-mentioned particle size distribution is obtained, for example, through sieving of copper powder having various particle sizes, or formed with use of copper eluted from waste circuit boards. In particular, the latter recycled copper powder contains many fine particles, and hence the fine copper powder as described above can be easily obtained.

Further, copper is much more expensive than iron. Thus, in order to achieve cost reduction, as described above, the ratio of the copper-based powder is set to be low while the ratio of the iron-based powder is set to be high. In addition, with use of the recycled copper powder as described above, further cost reduction can be achieved, and burden on the environment can be reduced.

The sintered metal bearing 8 has a substantially cylindrical shape, and has an inner peripheral surface 8a which functions as a radial bearing surface. The inner peripheral surface 8a of the sintered metal bearing 8 is provided with radial dynamic pressure generating portions for generating a dynamic pressure action in the lubricating oil in the radial bearing gaps. In this embodiment, as illustrated in FIG. 3, at two points separate from each other in the axial direction on the inner peripheral surface 8a of the sintered metal bearing 8, dynamic pressure generating grooves 8a1 and 8a2 in a herringbone pattern are formed as the radial dynamic pressure generating portions. In this case, a top surface (most inner diameter-side surface) of a hill portion functions as the radial bearing surface. A surface aperture ratio of this surface is set at 2% or more to 15% or less, for example, by the rotation sizing. In an upper dynamic pressure generating groove region, the dynamic pressure generating grooves 8a1 are formed to be asymmetrical in the axial direction. Specifically, with respect to a belt-like part formed along a substantially central, portion in the axial direction of the hill portion, an axial dimension X₁ of upper grooves is set to be larger than an axial dimension X₂ of lower grooves (X₁>X₂). In a lower dynamic pressure generating groove region, the dynamic pressure generating grooves 8a2 are formed to be symmetrical in the axial direction. By a difference in pumping capacity between the upper and lower dynamic pressure generating groove regions as described above, during rotation of the shaft member 2, the oil filled between the inner peripheral surface 8a of the sintered metal bearing 8 and the outer peripheral surface of the shaft portion 2a is forced downward.

The sintered metal bearing 8 has a lower end surface 8c which functions as a thrust bearing surface. The lower end surface 8c of the sintered metal bearing 8 is provided with a thrust dynamic pressure generating portion for generating a dynamic pressure action in an oil film within a thrust bearing gap. In this embodiment, as illustrated in FIG. 4, dynamic pressure generating grooves 8c1 in a spiral pattern are formed as the thrust dynamic pressure generating portion in the lower end surface 8c of the sintered metal bearing 8. The sintered metal bearing 8 has an outer peripheral surface 8d comprising axial grooves 8d1 formed at a plurality of equiangular points (three points in the illustration). Under a state in which the outer peripheral surface 8d of the sintered metal bearing 8 and an inner peripheral surface 7c of the housing 7 are fixed to each other, the axial grooves Bd1 function as oil communication paths, and pressure balance inside the bearing can be maintained within an appropriate range by those communication paths.

The sealing member 9 is obtained by forming a resin material, a metal material, or the like into an annular shape, and is arranged along an inner periphery of an upper end portion of the side portion 7a of the housing 7 as illustrated in FIG. 2. The sealing member 9 has an inner peripheral surface 9a facing, in a radial direction, the tapered surface 2a2 provided along an outer periphery of the shaft portion 2a, and a sealing space S gradually reduced downward in radial dimension is formed therebetween. A capillary force of the sealing space S causes the lubricating oil to be drawn into an inner side of the bearing. In this way, oil leakage is prevented. In this embodiment, the tapered surface 2a2 is formed on the shaft portion 2a side, and hence the sealing space S functions also as a centrifugal force seal. The oil surface of the lubricating oil filling an interior space of the housing 7 sealed by the sealing member 9 is maintained within a range of the sealing space S. In other words, the sealing space S has a capacity sufficient to absorb a volumetric change of the lubricating oil.

After the above-mentioned components are assembled by a predetermined procedure into a form illustrated in FIG. 2, the lubricating oil is charged into a bearing inner space. As a result, inner pores of the sintered metal bearing 8 are impregnated with the lubricating oil, and other spaces (radial bearing gaps and the like) are filled with the lubricating oil. In this manner, the fluid dynamic bearing device 1 as a completed product is obtained. Various oils can be used as the lubricating oil filling the inside of the fluid dynamic bearing device 1. Specifically, as the lubricating oil supplied to the fluid dynamic bearing device 1 for a disk drive device such as an HDD, it is preferred to use ester-based lubricating oils excellent in low evaporation rate and low viscosity, such as dioctyl sebacate (DOS) and dioctyl azelate (DOZ) in consideration of temperature change during use and transportation.

In the fluid dynamic bearing device 1 structured as described above, in accordance with the rotation of the shaft member 2, the radial bearing gaps are formed between the inner peripheral surface 8a (radial bearing surface) of the sintered metal bearing 8 and the outer peripheral surface 2a1 of the shaft portion 2a. Pressures of the oil films formed in those radial bearing gaps are increased by the dynamic pressure generating grooves 8a1 and 8a2 formed in the inner peripheral surface 8a of the sintered metal bearing 8. By the dynamic pressure actions of those dynamic pressure generating grooves 8a1 and 8a2, there are formed a first radial bearing portion R1 and a second radial bearing portion R2 which support the shaft portion 2a in a non-contact manner so that the shaft portion 2a is freely rotatable.

Simultaneously, the oil films are formed respectively in the thrust bearing gap between an upper end surface 2b1 of the flange portion 2b and the lower end surface 8c (thrust bearing surface) of the sintered metal bearing 8, and in the thrust bearing gap between a lower end surface 2b2 of the flange portion 2b and the upper end surface 7b1 of the bottom portion 7b of the housing 7. The dynamic pressure actions of the dynamic pressure generating grooves cause the pressures of the oil films to be increased. By those dynamic pressure actions, there are formed a first thrust bearing portion T1 and a second thrust bearing portion T2 which support the flange portion 2b in a non-contact manner so that the flange portion 2b is freely rotatable in both sides in a thrust direction.

The first invention of this application is not limited to the embodiment described above. For example, in the embodiment described above, although the dynamic pressure generating grooves in a herringbone pattern are exemplified as the radial dynamic pressure generating portions, the first invention is not limited thereto. For example, there may be employed what is called a step bearing or a wave bearing, or a multi-lobe bearing. Alternatively, there may be employed what is called a cylindrical bearing in which the inner peripheral surface 8a of the sintered metal bearing 8 and the outer peripheral surface 2a1 of the shaft member 2 are each formed as a cylindrical surface so that none of the radial bearing portions R1 and R2 as dynamic pressure generating portions is formed.

Still further, in the embodiment described above, although the dynamic pressure generating grooves in a spiral pattern are exemplified as the thrust dynamic pressure generating portions, the first invention is not limited thereto. For example, the step bearing or the wave bearing may be employed. Alternatively, there may be employed a pivot bearing in which the thrust bearing portions T1 and T2 support an end portion of the shaft member in a contact manner. In this case, the lower end surface 8c of the sintered metal bearing 8 does not function as the thrust bearing surface.

Yet further, in the embodiment described above, the radial dynamic pressure generating portions are formed on the inner peripheral surface 8a of the sintered metal bearing 8, and the thrust dynamic pressure generating portions are formed on the lower end surface 8c of the sintered metal bearing 8 and the inner bottom surface (upper end surface 7b1) of the housing 7. However, the radial dynamic pressure generating portions and the thrust dynamic pressure generating portions may be formed on surfaces facing those surfaces across the bearing gaps, that is, the outer peripheral surface 2al of the shaft portion 2a and the upper end surface 2b1 and the lower end surface 2b2 of the flange portion 2b.

Yet further, the fluid dynamic bearing device of the first invention of this application is not limited to use for a spindle motor to be used in a disk drive device such as an HDD as described above, and may be suitably used as follows: in a small motor for information apparatus to be used at high-speed rotation, such as a spindle motor for driving magneto-optical disks; for supporting a rotary shaft of, for example, a polygon scanner motor of a laser beam printer; or in a motor of a cooling fan for electrical apparatus.

### Example 1

For verification of effects of the first invention of this application, an abrasion test and an oil permeability measurement test were each carried out on a sintered metal bearing formed of raw material powder mainly containing iron-based powder and copper-based powder containing fine copper powder at a predetermined rate or more, and a sintered metal bearing formed of raw material powder having a related-art composition. Then, characteristics of the sintered metal bearings were evaluated relative to each other.

Here, for testing materials, CE-15 made by Fukuda Metal Foil & Powder Co., Ltd. was used as the pure copper powder for use in the copper-based powder, NC100.24 made by Höganäs AB was used as the pure iron powder for use in the iron-based powder, and DAP410L made by Daido Steel Co., Ltd. was used as the stainless steel powder. Moreover, in this experiment, for the raw material powder, there were used graphite powder, phosphorus powder, and tin powder as low melting point metal. ECB-250 made by Nippon Graphite Industries, Ltd. was used as the graphite powder, Sn-At-W350 made by Fukuda Metal Foil & Powder Co., Ltd. was used as the tin powder, and PNC60 made by Höganäs AB was used as iron-phosphorus alloy powder. Particle size distributions of the respective types of powder, which exclude the pure copper powder, are as shown in Table 2 to Table 6. Moreover, compositions of the respective types of raw material powder (blending examples A to D) for use in test pieces of the abrasion test are as shown in Table 7. Here, in the copper-based powder that was used, the occupancy ratio of the fine copper powder was set at a half (fine copper powder: related-art copper powder=1:1).

TABLE 2
Pure Iron Powder (NC100.24)

| Particle size | wt % |
|---|---|
| >150 μm | 0.8 |
| 106-150 μm | 27.2 |
| 75-106 μm | 31.1 |
| 45-75 μm | 24.3 |
| <45 μm | 16.6 |

TABLE 3
Stainless Steel Powder (DAP410L)

| Particle size | | wt % |
|---|---|---|
| >149 | μm | 0.2 |
| 105-149 | μm | 11.4 |
| 74-105 | μm | 20.0 |
| 63-74 | μm | 13.4 |
| 44-63 | μm | 20.8 |
| <44 | μm | 34.2 |

TABLE 4
Tin Powder (Sn-At-W350)

| Particle size | wt % |
|---|---|
| ≧45 μm | 97.0 |
| <45 μm | 3.0 |

TABLE 5
Graphite Powder (ECB-250)

| Particle size | | wt % |
|---|---|---|
| 150 | μm or more | 99.4 |
| 106-150 | μm | 0.4 |
| 63-106 | μm | 0.1 |
| 63 | μm or less | 0.1 |

TABLE 6
Iron-Phosphorus Alloy Powder (PNC60)

| Particle size | | wt % |
|---|---|---|
| 150-212 | μm | 0.1 |
| 106-150 | μm | 21.3 |
| 75-106 | μm | 33.1 |
| 45-75 | μm | 21.9 |
| <45 | μm | 23.6 |

TABLE 7

| | Blending | Blending | Blending | Blending |
|---|---|---|---|---|
| | example A | example B | example C | example D |
| Related-art copper | 28.85 | 13.85 | 28.85 | 18.79 |
| powder | | | | |
| Fine copper powder | 28.85 | 13.85 | 28.85 | 18.79 |
| Pure iron powder | 40 | 70 | | |
| Stainless steel powder | | | 40 | 20 |
| Iron-phosphorus alloy | | | | 40 |
| powder | | | | |
| Graphite powder | 0.8 | 0.8 | 0.8 | 0.8 |
| Tin powder | 1.5 | 1.5 | 1.5 | 1.5 |

Unit: wt %

(Abrasion Test)

Four types of the raw material powder (blending examples A to D), which exhibit four types of blending ratios shown in Table 7 above, were compressed to obtain compressed bodies, and test pieces for the abrasion test were obtained from sintered bodies obtained by sintering these compressed bodies while varying the sintering temperature (to 850° C., 950° C., 1,050° C.). In this case, sintered densities of the sintered bodies according to the respective blending examples were differentiated from one another so that the same oil content (12 vol %) was achieved. Specifically, the sintered density in a case of the blending example A was set at 7.20 g/cm³, the sintered density in a case of the blending example B was set at 6.9 g/cm³, the sintered density in a case of the blending example C was set at 7.20 g/cm³, and the sintered density in a case of the blending example D was set at 7.10 g/cm³. Moreover, dimensions of a completed product of each of the test pieces were set at φ (outer diameter) 5.0 mm×φ (inner diameter) 2.5 mm×t (axial width) 5.0 mm. By using the above-mentioned test pieces, the abrasion test was conducted under the following testing conditions.

Opposite material

Material: SUS420J2

Dimensions: φ (outer diameter) 40 mm×t (axial width) 4 mm

Peripheral speed (number of revolutions): 400 rpm

Contact pressure (load): 14.7 N

Lubricating oil: ester oil (viscosity: 12 mm²/s)

Test time: 3 hrs

(Oil Permeability Measurement Test)

For a measurement test of an amount of permeated oil (that is, oil permeability), among the test pieces used in the abrasion test, there were used: one in which the related-art copper powder is entirely substituted for the fine copper powder in the blending example B (Related-art structure); one in which the occupancy ratio of the fine copper powder in the copper-based powder in the blending example B is set at one-third (Present invention structure 1); one in which the occupancy ratio of the fine copper powder in the copper-based powder in the blending example B is set at a half (Present invention structure 2); and one in which the copper-based powder is formed of only the fine copper powder (Present invention structure 3). Compositions of the respective types of raw material powder (Related-art structure, Present invention structures 1 to 3) are as shown in Table 8. For the types of raw material powder according to the respective compositions, oil permeabilities in a case of varying the sintered density and the sintering temperature were measured. For each of the compositions, two types of the sintering temperature, which were 850° C. and 950° C., were set. Moreover, for each of the compositions, five types of the sintered density were set, which were 6.70, 6.90, 7.10, 7.30, and 7.50 g/cm³. Completed product dimensions of each of the test pieces were set at φ (outer diameter) 5.0 mm×φ (inner diameter) 2.5 mm×t (axial width) 5.0 mm.

TABLE 8

| | | Present | Present | Present |
|---|---|---|---|---|
| | Related-art | invention | invention | invention |
| | structure | structure 1 | structure 2 | structure 3 |
| Related-art copper | 27.7 | 18.47 | 13.85 | |
| powder | | | | |
| Fine copper powder | | 9.23 | 13.85 | 27.7 |
| Pure iron powder | 70 | 70 | 70 | 70 |
| Graphite powder | 0.8 | 0.8 | 0.8 | 0.8 |
| Tin powder | 1.5 | 1.5 | 1.5 | 1.5 |

Unit: wt %

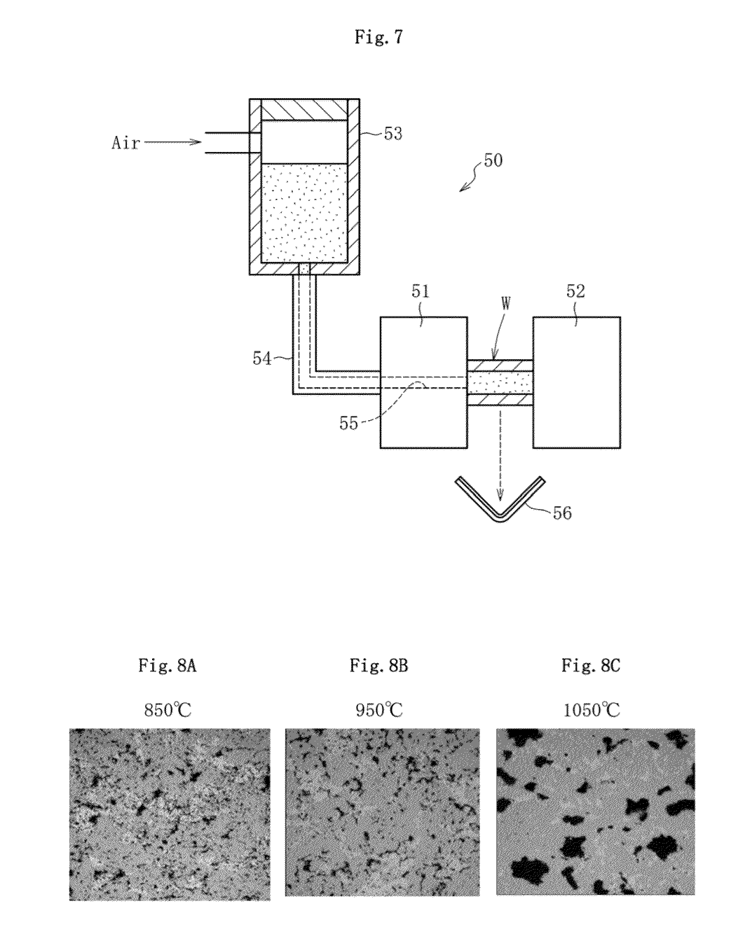

The measurement test of the amount of permeated oil (oil permeability) was conducted by using an oil permeability testing apparatus 50 illustrated in FIG. 7. This oil permeability testing apparatus 50 comprises holding portions 51 and 52 for sandwiching and fixing a cylindrical sample W (sintered metal bearing) from both sides in the axial direction, and a tank 53 for storing oil. Spaces between both axial end portions of the sample W and the holding portions 51 and 52 are sealed by rubber washers (not shown). The oil (diester-based lubricating oil) stored in the tank 53 is supplied into a space along an inner periphery of the sample W through a pipe 54 and a communication path 55 in the holding portion 51. With use of the above-mentioned apparatus 50, in a room temperature environment (26° C. to 27° C.), the tank 53 was pressurized with an air pressure of 0.4 MPa so that the oil was supplied from an inner diameter side to an outer diameter side of the sample W in a state in which lubricating oil was not impregnated for ten minutes. Droplets of the oil, which had seeped and dripped from the outer periphery surface of the sample W during this period, were collected by being permeated into a cloth (or sheet) 56 arranged below the sample W. Then, the oil permeability was calculated based on a weight difference of the cloth 56 before and after the test, to thereby measure the oil permeability (g/10 min). Moreover, ester-based oil (12 mm²/s at 40° C.) was used as the lubricating oil. A test temperature was set at 25° C.

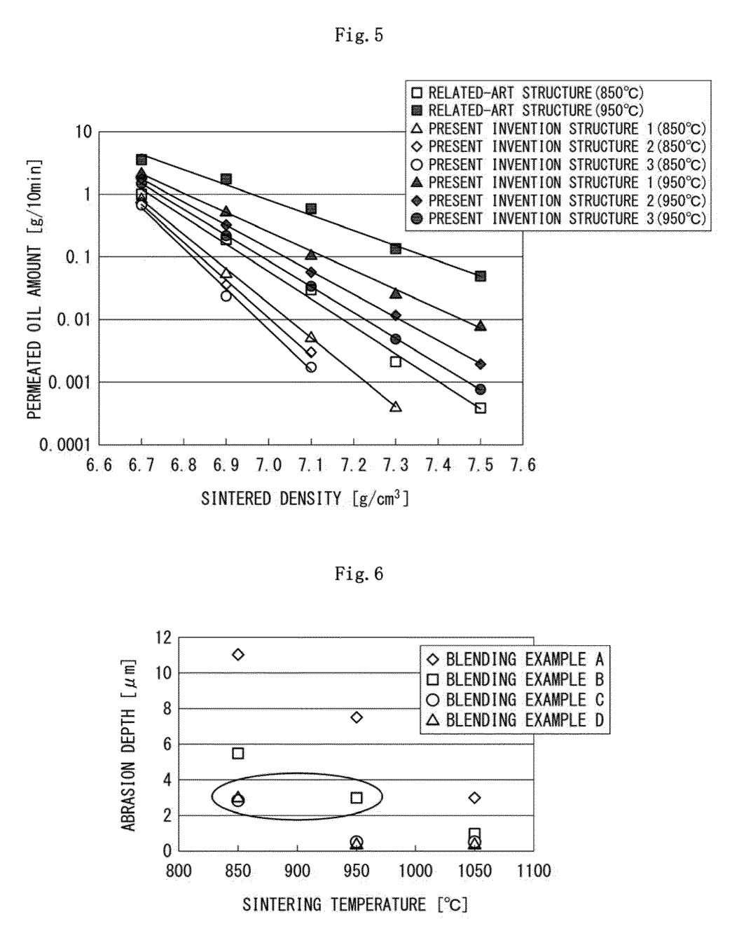

FIG. 6 shows measurement results of the abrasion test, and FIG. 5 shows measurement results of the oil permeability measurement test. First, as shown in FIG. 6, it is understood that an abrasion depth becomes smaller as raising the sintering temperature in any one of the blending examples. Moreover, the abrasion depth becomes small as a whole when the stainless steel powder is used for the iron-based powder. However, it is understood that, even in the case of using only the pure iron powder, by increasing the blending ratio of the iron-based powder through use of the fine copper powder for the copper-based powder (blending example B), high abrasion resistance is exhibited. Specifically, it is understood that an abrasion depth in the case where the stainless steel powder is blended and the sintering is carried out at 850° C. and an abrasion depth in the case where the fine copper powder is used, only the pure iron powder is used for the iron-based powder, and the sintering is carried out at 950° C. indicate similar values.

Next, a description is made of results of the oil permeability measurement test. It is understood that, as shown in FIG. 5, the oil permeability is decreased by using the fine copper powder more than in the case of using only the related-art copper powder in the case where the sintering temperature is the same. Moreover, the following is understood. In the case where the sintering is carried out by using the fine copper powder at a temperature (850° C.) approximate to the related-art temperature in order to set the oil permeability within a range (0.10 to 2.00 g/10 min) corresponding to an oil content (10 to 14 vol %) usually set in the case where the sintered body is used for the fluid dynamic bearing device exemplified above, it is necessary to lower the sintered density to a considerably low level. Meanwhile, the sintering temperature is raised to 950° C., and thus it becomes possible to bring both of the oil permeability and the sintered density into allowable ranges.

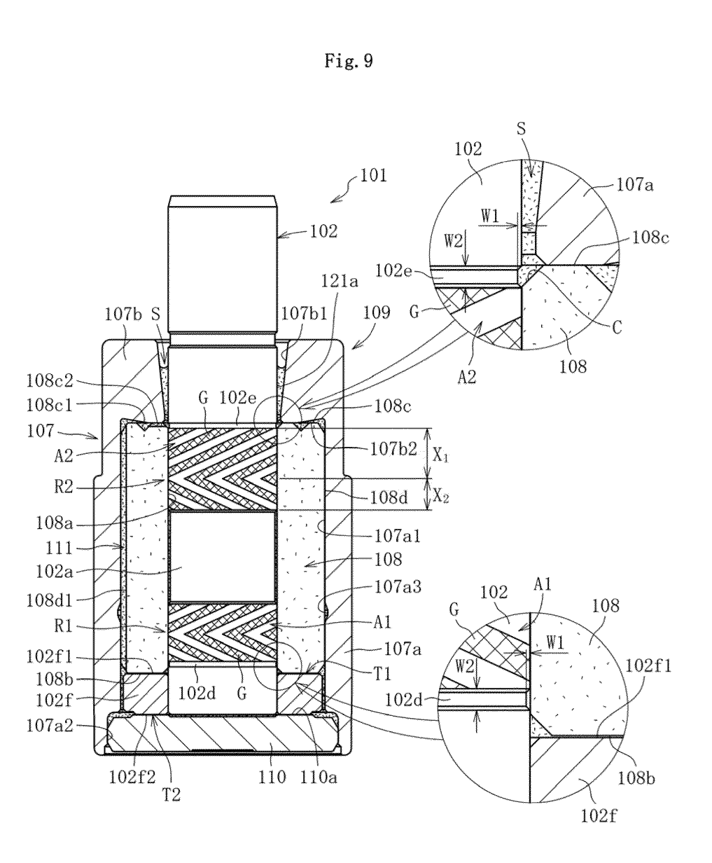

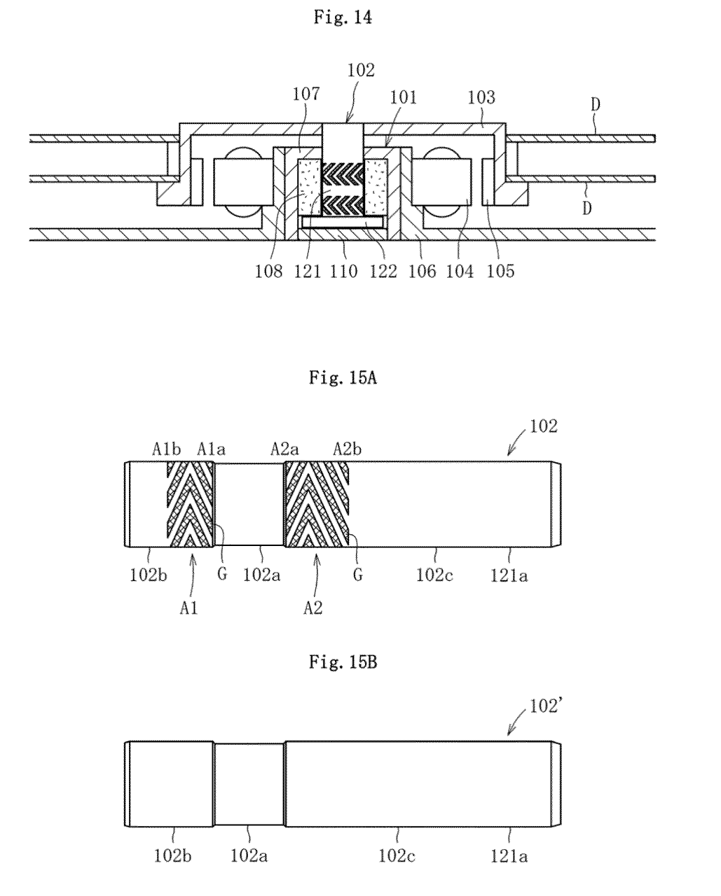

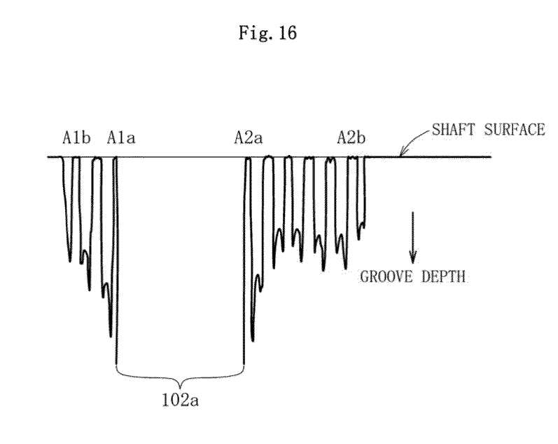

Based on the drawings, a description is made below of an embodiment, in which a second invention of this application is applied to a fluid dynamic bearing device for use in the same disk drive device as in FIG. 14, such as an HDD. A fluid dynamic bearing device 101 of FIG. 9 comprises, as components: a bearing member 109 in which both end portions in an axial direction are opened; a shaft member 102 inserted along an inner periphery of the bearing member 109; and a cover member 110 that closes one end opening of the bearing member 109. An inner space of the fluid dynamic bearing device 101 is filled with lubricating oil (indicated by densely scattered points) as a lubricating fluid.

(Bearing Member)

In this embodiment, the bearing member 109 comprises: a bearing sleeve 108 inserted along an inner periphery of the shaft member 102; and a housing 107 that holds (fixes) the bearing sleeve 108 on an inner periphery thereof. Note that, in the following, the description is advanced, for the sake of convenience, on the assumption that a side on which the cover member 110 is provided is defined as a lower side and that an opposite side thereto in the axial direction is defined as an upper side.

The bearing sleeve 108 is cylindrically formed of a porous body of a sintered metal, for example, a porous body of a sintered metal containing copper or iron as a main component. The bearing sleeve 108 can also be formed of other porous body made of a material other than the sintered metal, for example, can be formed of a porous resin or ceramics, or can also be formed of a solid (non-porous) metal material such as brass and stainless steel.

An inner peripheral surface 108a of the bearing sleeve 108 is formed into a smooth cylindrical surface free from irregularities, and moreover, an outer peripheral surface 108d of the bearing sleeve 108 is formed into a smooth cylindrical surface free from irregularities except that axial grooves 108d1 are provided at one or a plurality of positions thereof in a circumferential direction. A lower end surface 108b of the bearing sleeve 108 is formed into a flat surface free from irregularities, and on an upper end surface 108c thereof, there are formed: an annular groove 108c1; and a radial groove 108c2 having an outer diameter end connected to the annular groove 108c1.

The cover member 110 is formed of a metal material into a plate shape. Although details are described later, an upper end surface 110a of the cover member 110 has an annular region that forms a thrust bearing gap of a second thrust bearing portion T2 with a lower end surface 102f2 of a flange portion 102f of the shaft member 102. This annular region is formed into a smooth flat surface, and does not have a recessed portion for causing the lubricating oil interposed in the thrust bearing gap to generate the dynamic pressure action, such as the dynamic pressure generating groove, provided thereon.

The housing 107 is formed of a molten material (for example, a solid metal material such as brass and stainless steel) into a substantially cylindrical shape in which both ends in the axial direction are opened. The housing 107 integrally comprises: a body portion 107a that holds the bearing sleeve 108 and the cover member 110 on an inner periphery thereof; and a sealing portion 107a extended from an upper end of the body portion 107a to an inner diameter side thereof. On an inner peripheral surface of the body portion 107a, there are provided: a small-diameter inner peripheral surface 107a1 with a relatively small diameter; and a large-diameter inner peripheral surface 107a2 with a relatively large diameter, and the bearing sleeve 108 and the cover member 110 are fixed to the small-diameter inner peripheral surface 107a1 and the large-diameter inner peripheral surface 107a2, respectively.

Means for fixing the bearing sleeve 108 and the cover member 110 to the housing 107 is arbitrary, and the bearing sleeve 108 and the cover member 110 can be fixed to the housing 107 by appropriate means such as press-fit, adhesion, press-fit adhesion, and welding. In this embodiment, the bearing sleeve 108 is fixed to the inner periphery of the housing 107 by so-called gap adhesion, in which the bearing sleeve 108 is gap-fitted to the small-diameter inner peripheral surface 107a1 of the body portion 107a, and an adhesive is interposed in this gap. On a predetermined position of the small-diameter inner peripheral surface 107a1 in the axial direction, an annular groove 107a3 that functions as an adhesive reservoir is formed. The adhesive is filled into this annular groove 107a3, followed by curing, and thus adhesion strength of the bearing sleeve 108 against the housing 107 is enhanced.

An inner peripheral surface 107b1 of the sealing portion 107b is formed into a tapered surface shape gradually reduced downward in diameter, and forms a wedge-like sealing space S, which is gradually reduced downward in radial dimension, with an outer peripheral surface 121a of the opposing shaft member 102. The upper end surface 108c of the bearing sleeve 108 abuts against (an inner-diameter side region of) a lower end surface 107b2 of the sealing portion 107b, and thus the bearing sleeve 108 is positioned in the axial direction relatively with respect to the housing 107.

An outer diameter-side region of the lower end surface 107b2 of the sealing portion 107b is gradually retreated upward toward the outer diameter side, and forms an annular gap with the upper end surface 108c of the bearing sleeve 108. An inner diameter end portion of this annular gap connects to the annular groove 108c1 of the upper end surface 108c of the bearing sleeve 108.

The housing 107 having the above-mentioned configuration can also be an injection-molded product of a resin. In this case, the housing 107 may be injection molded of a resin while taking the bearing sleeve 108 as an insertion component. Moreover, the housing 107 can also be an injection-molded product of a low melting point metal represented by a magnesium alloy, an aluminum alloy, and the like, or can also be a so-called MIM-molded product.

(Shaft Member)

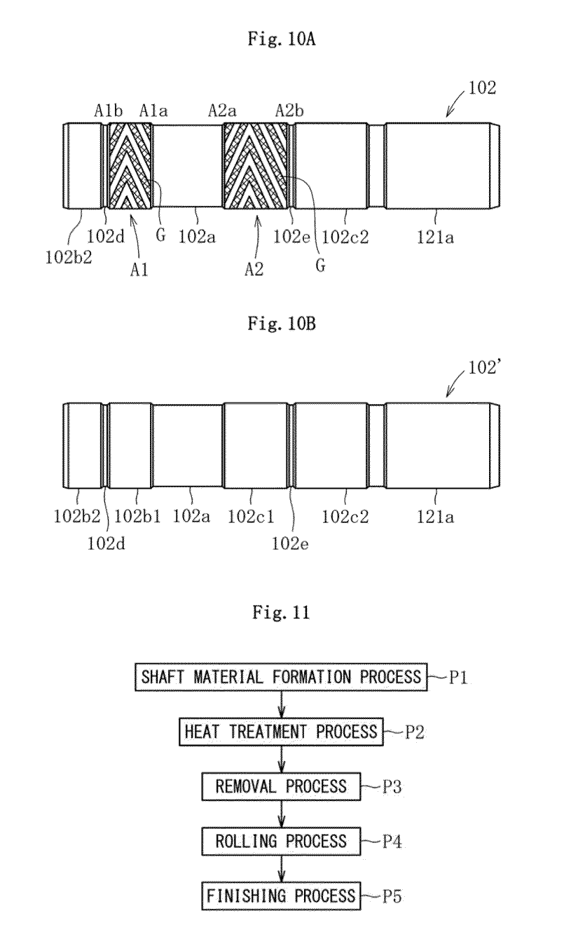

As illustrated in FIG. 9 and FIG. 10A, on the shaft member 102, at two positions of the outer peripheral surface 121a in the axial direction, there are formed dynamic pressure generating groove patterns A1 and A2 which form radial bearing gaps with the inner peripheral surface 108a of the opposing bearing sleeve 108. This shaft member 102 is formed of a shaft material 102′ with a shape of FIG. 10B. This shaft material 102′ is obtained by forming, for example, quenched stainless steel (for example, SUS420J2) and the like into the illustrated shape by forging and the like. On an outer peripheral surface of the shaft material 102′, there are formed: a cylindrical clearance portion 102a; cylindrical portions 102b1 and 102c1 as dynamic pressure generating groove forming regions formed so as to sandwich the clearance portion 102a from both sides; annular clearance grooves 102d and 102e on outer sides of the cylindrical portions 102b1 and 102c1; and cylindrical portions 102b2 and 102c2 on outer sides of the annular clearance grooves 102d and 102e.

A depth of the clearance portion 102a is deeper than a depth of dynamic pressure generating grooves G formed on the cylindrical portions 102b1 and 102c1, and for example, can be set at 20 μm or more to 50 μm or less. The cylindrical portions 102b1 and 102c1 are regions on which the dynamic pressure generating grooves G are formed by rolling formation, and an outer diameter thereof is set equal to that of the cylindrical portions 102b2 and 102c2. A depth W1 (refer to partially enlarged views of FIG. 9) of the annular clearance grooves 102d and 102e can be set, for example, at 20 μm or more to 50 μm or less. It is desired that the depth W1 be set to have approximately the same depth as the clearance portion 102a.

A width W2 of the clearance grooves 102d and 102e can be set, for example, at 0.5 mm or less. In particular, the sealing portion S is present on the outside (upper side) of the clearance groove 102e as one in the pair, and accordingly, this clearance groove 102e is prevented from eating into the sealing portion S. In usual, In usual, in a gap between the dynamic pressure generating groove pattern A2 and the sealing portion S, there is a margin of an amount of a chamfer C on an end portion of the bearing sleeve 108 of approximately 0.3 mm, and of an amount of an end surface of the sealing portion and a flat portion thereof. Accordingly, by using this margin, the width 0.5 mm of the clearance groove 102e is ensured. When the width of the clearance groove 102e exceeds 0.5 mm, a part of the clearance groove 102e sometimes enters the sealing space S depending on design conditions. Then, a tip end gap of the sealing space S is widened, capillary force thereof is weakened, and sealing performance thereof is lowered.

On the dynamic pressure generating groove patterns A1 and A2, a plurality of the dynamic pressure generating grooves G (illustrated by cross hatching in FIG. 9) for causing the lubricating oil interposed in the radial bearing gaps to generate the dynamic pressure action are respectively provided in the circumferential direction. Here, the plurality of dynamic pressure generating grooves G are arrayed in a herringbone pattern. Note that, as a matter of course, it is also possible to form dynamic pressure generating grooves with a pattern other than the herringbone pattern.

In this embodiment, the respective dynamic pressure generating grooves G provided on the lower dynamic pressure generating groove pattern A1 are formed symmetrically in the axial direction. The respective dynamic pressure generating grooves G provided on the upper dynamic pressure generating groove pattern A2 are formed asymmetrically in the axial direction with respect to an axial center m (axial center of upper and lower inter-inclined groove regions), and an axial dimension X₁ of the upper region with respect to the axial center m is set larger than an axial dimension X₂ of the lower region. A groove depth of the respective dynamic pressure generating grooves G is designed at approximately a few micrometers, for example, within a range from 2.5 μm or more to 5 μm or less.

On the outer peripheral surface 121a of the shaft member 102, between the two dynamic pressure generating groove patterns A1 and A2, the cylindrical clearance portion 102a, which is retreated to a lower side than bottom portions of the dynamic pressure generating grooves G (formed to have a smaller diameter), is provided. The clearance portion 102a as described above is provided on the outer peripheral surface 121a of the shaft member 102, and thus a cylindrical lubricating oil reservoir is formed with the inner peripheral surface 108a of the bearing sleeve 108, which is formed into a cylindrical surface with a constant inner diameter. In this way, during an operation of the bearing, it becomes possible to always fill the two radial bearing gaps, which are adjacent to the lubricating oil reservoir in the axial direction, with abundant lubricating oil, and accordingly, rotation accuracy in the radial direction is stabilized. Moreover, a gap width of the radial gap is ensured to be larger than those of the radial bearing gaps, and accordingly, a torque loss can be reduced, thereby contributing to reduction of power consumption of the motor.

The shaft member 102 and the shaft material 102′ are configured as described above. A quenched shaft formed by quenching the shaft material 102′ is introduced between a pair of upper and lower rolling molds, the rolling molds are thereafter moved relatively in the horizontal direction, and dynamic pressure generating groove forming portions of the rolling molds are thrust against an outer peripheral surface of the quenched shaft. In such a way, on the outer peripheral surface of the quenched shaft, a material located in a region against which protruding portions of the dynamic pressure generating groove forming regions are thrust flows plastically and is extruded to a periphery thereof, and hill portions which define the dynamic pressure generating grooves are formed, and simultaneously therewith, the dynamic pressure generating grooves G are formed.

(Production Process of Shaft Member)

As illustrated in FIG. 11, the shaft member 102 having the above-mentioned configuration is completed in such a manner that the flange portion 102f produced in an independent process is fixed to the lower end of the shaft member 102 produced sequentially through a shaft material formation process P1, a heat treatment process P2, a removal process P3, a rolling process P4, and a finishing process P5.

(1) Shaft Material Formation Process P1

In this shaft material formation process P1, predetermined processing is implemented for a short bar material cut out to a predetermined length from a long bar material, and thus the shaft material 102′ of FIG. 10B is obtained, in which regions excluding the dynamic pressure generating grooves G are finished to shapes approximate to those of the shaft member 102 as a completed product. Such shapes in FIG. 10B can be obtained by plastic processing such as forging and by machining such as turning.

(2) Heat Treatment Process P2

In this heat treatment process P2, in the shaft material 102′ obtained in the shaft material formation process P1, at least the outer peripheral surface thereof is subjected to heat treatment. Thus, a quenched shaft is obtained, which comprises a surface hardened layer in which hardness is HV450 or more, preferably, HV500 or more. In usual, it is common that this heat treatment process P2 is performed after the rolling process P4; however, such an order is reversed, and thus work in subsequent processes can be facilitated, and so on. A heat treatment method may be arbitrary, and quenching such as high frequency quenching, vacuum quenching, carbonizing quenching, and carbonitriding quenching, tempering after the quenching, and the like can be appropriately combined with one another. The heat treatment just needs to be implemented so that a surface hardened layer is formed so as to have a larger thickness than the groove depth of the dynamic pressure generating grooves G to be formed, and does not always have to be implemented so that the whole of the shaft material 102′ can be hardened (quenched).

(3) Removal Process P3

In this rough finishing process P3, an oxide film is removed, which is also called a black scale and is formed on a surface of the quenched shaft as the quenched shaft (surface hardened layer) is being formed by implementing the heat treatment for the shaft material 102′. The black scale (oxide film) is removed, for example, by implementing centerless polishing for the quenched shaft. Note that, by the centerless polishing, removal of deformation by the heat treatment and dimension determination can also be expected.

(4) Rolling Process P4

In this rolling process P4, rolling processing is implemented for the surface hardened layer of the quenched shaft (from which the black scale on the surface is removed), and thus the dynamic pressure generating groove patterns A1 and A2 by the dynamic pressure generating grooves G are formed on the cylindrical portions 102b1 and 102c1 as the dynamic pressure surface forming regions on the outer peripheral surface of the quenched shaft. In this embodiment, by using the pair of rolling molds provided so as to be relatively slidable to each other, the dynamic pressure generating groove patterns A1 and A2 are formed by rolling on the outer peripheral surface of the quenched shaft.

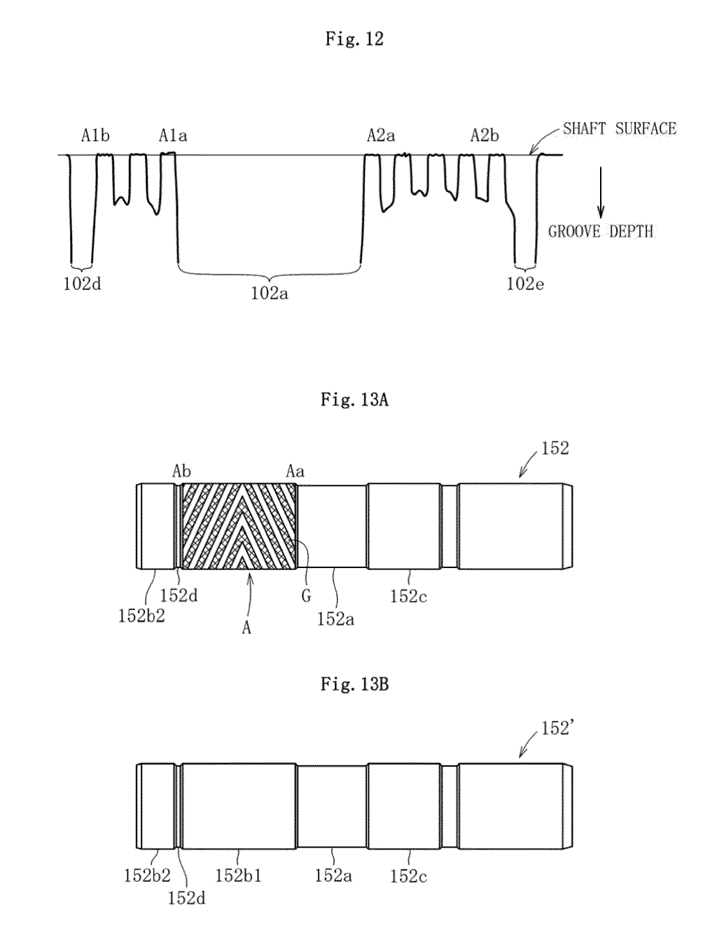

At the time when the dynamic pressure generating groove patterns A1 and A2 are formed by rolling, because both sides of each of the cylindrical portions 102b1 and 102c1 are adjacent to the clearance portion 102a and the clearance grooves 102d and 102e, flows of the material in the outside directions of the cylindrical portions 102b1 and 102c1 in the axial direction are generated uniformly right and left along with the rolling. Thus, as illustrated in a groove depth measurement result of FIG. 12, the dynamic pressure generating groove patterns A1 and A2 are obtained, in which depth gradients of the dynamic pressure generating grooves G are balanced between the clearance portion 102a side and the clearance groove 102d and 102e side.

(5) Finishing Process P5

In this finishing process P5, the outer peripheral surface of the quenched shaft, on which the dynamic pressure generating groove patterns A1 and A2 are formed by rolling in the rolling process P4, is finished to predetermined accuracy. In such a way, the shaft member 102 as a completed product is obtained. Then, as illustrated in FIG. 9, the flange portion 102f is mounted to the cylindrical portion 102b as one in the pair of the shaft member 102 as a completed product. For example, the flange portion 102f is formed into an annular shape by the same type of stainless steel as that of the shaft material 102′ or by a porous body of a sintered metal, and is fixed to an outer periphery of the lower end of the shaft member 102 by appropriate means such as press-fit, adhesion, press-fit adhesion, and welding. Moreover, the disk hub 3 is mounted to the other cylindrical portion 102c2 as illustrated in FIG. 14.

(Operation of Fluid Dynamic Bearing Device)

In the fluid dynamic bearing device 101 configured as described above, when the shaft member 102 rotates, the radial bearing gaps are respectively formed between the dynamic pressure generating groove patterns A1 and A2 of the shaft member 102 and the opposing inner peripheral surface 108 of the bearing sleeve 108. Then, following the rotation of the shaft member 102, pressures of the oil films formed on both of the radial bearing gaps are enhanced by the dynamic pressure actions of the dynamic pressure generating grooves G and Aa, and as a result, radial bearing portions R1 and R2 which support the shaft member 102 in the radial direction in a non-contact manner are formed at two posit ions in the axial direction so as to be spaced apart from each other.

At the same time, first and second thrust bearing gaps are formed respectively between a thrust bearing surface provided on an upper end surface 102f1 of the flange portion 102f and a lower end surface of the opposing bearing sleeve 108, and between a thrust bearing surface provided on a lower end surface 102f2 of the flange portion 102f and the upper end surface 110a of the opposing cover member 110. Then, following the rotation of the shaft member 102, pressures of the oil films formed on both of the thrust bearing gaps are enhanced by the dynamic pressure actions of the dynamic pressure generating grooves, and as a result, first and second thrust bearing portions T1 and T2 which support the shaft member 102 in both thrust directions in a non-contact manner are formed.

Moreover, the sealing space S exhibits a wedge shape in which a radial dimension is gradually reduced toward an inner side of the housing 107, and accordingly, the lubricating oil in the sealing space S is drawn to the inner side of the housing 107 by a drawing action of the capillary force. Moreover, the sealing space S has a buffer function to absorb a volume variation caused by a temperature change of the lubricating oil filled into the inner space of the housing 107, and always holds an oil level of the lubricating oil in the sealing space S within a range of an assumed temperature change. Therefore, leakage of the lubricating oil from the inside of the housing 107 is prevented effectively.

Moreover, as described above, with regard to the upper dynamic pressure generating groove G, the axial dimension X₁ of the upper region with respect to the axial center m is set larger than the axial dimension X₂ of the lower region. Accordingly, at the time of the rotation of the shaft member 102, drawing force for the lubricating oil by the dynamic pressure generating groove G becomes relatively larger in the upper region in comparison with the lower region. By such a pressure difference in the drawing force, the lubricating oil filled into the gap between the inner peripheral surface 108a of the bearing sleeve 108 and the outer peripheral surface 121a of the shaft member 102 flows downward. Then, the lubricating oil circulates through a route that is formed of, in the following order, the thrust bearing gap of the first thrust bearing portion T1, an axial fluid passage 111 formed of the axial groove 108d1 of the bearing sleeve 108, an annular space formed of an upper end outer periphery chamfer or the like of the bearing sleeve 108, and a fluid passage formed of the annular groove 108c1 and radial groove 108c2 of the bearing sleeve 108. Then, the lubricating oil is drawn again into the radial bearing gap of the second radial bearing portion R2.

By adopting such a configuration, a pressure balance of the lubricating oil is maintained, and at the same time, there can be solved such problems as generation of bubbles, which is caused by local occurrence of a negative pressure, leakage of the lubricating oil and generation of vibrations, which are caused by the generation of the bubbles, and the like. The sealing space S communicates with the above-mentioned circulation route, and accordingly, even in a case where the bubbles are mixed into the lubricating oil for some reason, the bubbles are discharged to the outside air from the oil level (gas-liquid interface) of the lubricating oil in the sealing space S in the event of circulating the bubbles together with the lubricating oil. Hence, an adverse effect by the bubbles is prevented far more effectively.

The description has been made above of the embodiment according to the second invention of this application; however, the second invention of this application is not limited to the above-mentioned embodiment. For example, in the above-mentioned embodiment, the lubricating oil is exemplified as a lubricating fluid filled into the inner space of the fluid dynamic bearing device 101; however, the second invention of this application is preferably applicable also to a fluid dynamic bearing device 101 using lubricating grease, a magnetic fluid, and further, gas such as air as the lubricating fluid.

Moreover, in the above-mentioned embodiment, the description has been made of the case where the second invention of this application is applied to the fluid dynamic bearing device 101, in which the shaft member 102 is on a rotation side, and the bearing sleeve 108 and the like are on a stationary side; however, the second invention of this application is preferably applicable also to a fluid dynamic bearing device 101, in which, on the contrary to the above, the shaft member 102 is on the stationary side, and the bearing sleeve 108 and the like are on the rotation side.

Moreover, as shapes of the shaft member and the shaft material, forms illustrated in FIG. 13A and FIG. 13B are also possible. In these forms, a dynamic pressure generating groove pattern A having the dynamic pressure generating grooves G is formed only on a cylindrical portion 152b1 as the dynamic pressure generating groove forming region located on one of a clearance portion 152a of the shaft member 152 (shaft material. 152′), and no dynamic pressure generating groove is provided on a cylindrical portion 152c located on the opposite side. On an opposite side to the clearance portion 152a in the dynamic pressure generating groove pattern A, a clearance groove 152d similar to the clearance groove 102d in FIG. 10 is formed, and the flange portion 102f in FIG. 9 is mounted to a cylindrical portion 152b2 located further on an outside of the clearance groove 152d. Also in the shaft member 152 in this form, depths of the dynamic pressure generating grooves G on one side Aa and the opposite side Ab of the dynamic pressure generating groove pattern A are free from the axial gradient and acquire a balance right and left similarly to FIG. 12. Thus, stable dynamic pressure effect and radial bearing rigidity are obtained.

Moreover, in the above-mentioned embodiment, the dynamic pressure generating grooves G for generating the dynamic pressure are formed by rolling on the outer peripheral surface 121a of the shaft member 102; however, the second invention of this application is also applicable to a case of forming the dynamic pressure generating grooves by rolling on the inner peripheral surface of the bearing member, which is opposed to the dynamic pressure generating groove patterns A1 and A2 of the shaft member 102, by using well-known rolling balls, instead of the dynamic pressure generating groove patterns concerned.

### REFERENCE SIGNS LIST

1 fluid dynamic bearing device
2 shaft member
2a shaft portion
2a1 outer peripheral surface
2a2 tapered surface
2b flange portion
2b1 upper end surface
2b2 lower end surface
3 disk hub
4 stator coil
5 rotor magnet
6 motor bracket
7 housing
7a side portion
7b bottom portion
7b1 upper end surface
7c inner peripheral surface
8 sintered metal bearing
8a inner peripheral surface
8a1, 8a2 dynamic pressure generating groove
8c lower end surface
8c1 dynamic pressure generating groove
8d outer peripheral surface
8d1 axial groove
9 sealing member
9a inner peripheral surface
D disk
R1, R2 radial bearing portion
T1, T2 thrust bearing portion
S sealing portion
101 fluid dynamic bearing device
102 shaft member
102′ shaft material
102a clearance portion
102b1, 102c1 cylindrical portion (dynamic pressure generating groove forming region)
102d, 102e, 152d clearance groove
102f flange portion
107 housing
108 bearing sleeve
109 bearing member
110 cover member
A, A1, A2 dynamic pressure generating groove pattern
Aa dynamic pressure generating groove
R1, R2 radial bearing portion
T1 first thrust bearing portion
T2 second thrust bearing portion

1. A sintered metal bearing, which is formed of raw material powder containing copper-based powder and iron-based powder as main components, the sintered metal bearing comprising a radial bearing surface along an inner periphery thereof,
wherein the copper-based powder comprises fine copper powder exhibiting a particle size distribution in which a ratio of particles with a diameter of less than 45 μm is 80 wt % or more, the fine copper powder occupying one-third or more of a whole of the copper-based powder in terms of a weight ratio, and
wherein a compressed body formed by compressing the raw material powder is sintered at 900° C. or more to 1,000° C. or less.

2. The sintered metal bearing according to claim 1, wherein a sintered density is set at 6.70 g/cm³ or more to 7.20 g/cm³ or less.

3. The sintered metal bearing according to claim 1, wherein oil permeability is set at 0.10 g/10 min or more to 2.00 g/10 min or less.

4. The sintered metal bearing according to claim 1, wherein an oil content is set at 10 vol % or more to 14 vol % or less.

5. The sintered metal bearing according to claim 1, wherein an occupancy ratio of the fine copper powder in the whole of the copper-based powder is set at a half or more.

6. The sintered metal bearing according to claim 1, wherein the iron-based powder comprises pure iron powder, and an occupancy ratio of the copper-based powder in the raw material powder is set at 10 wt % or more to 40 wt % or less.

7. The sintered metal bearing according to claim 1, wherein the iron-based powder comprises pure iron powder and stainless steel powder, and an occupancy ratio of the copper-based powder in the raw material powder is set at 10 wt % or more to 60 wt % or less.

8. The sintered metal bearing according to claim 1, wherein the raw material powder has graphite further blended therewith.

9. The sintered metal bearing according to claim 1, wherein the raw material powder has tin powder further blended therewith.

10. A fluid dynamic bearing device, comprising:
the sintered metal bearing according to claim 1;
a shaft arranged along an inner periphery of the sintered metal bearing; and
lubricating oil impregnated into the sintered metal bearing.
